(19) United States
(12) Patent Application Publication
(10) Pub. No.: US 2026/0082223 A1
(43) Pub. Date: Mar. 19, 2026

(54) INITIATION OF SECONDARY AUTHENTICATION FOR A SUBSCRIBER ENTITY

(71) Applicant: Telefonaktiebolaget LM Ericsson (publ), Stockholm (SE)

(72) Inventors: Kazi Wali ULLAH, Espoo (FI); Patrik SALMELA, Espoo (FI); Patrik TEPPO, Bobäck (FI); Abu Shohel AHMED, Espoo (FI)

(21) Appl. No.: 19/110,679

(22) PCT Filed: Sep. 27, 2022
(86) PCT No.: PCT/EP2022/076856

§ 371 Date: Mar. 11, 2025

(51) Int. Cl. H04W 12/06; H04L 61/4511; H04W 24/08

(52) U.S. Cl. CPC H04W 12/06; H04L 61/4511; H04W 24/08

(57) ABSTRACT

There is provided techniques for initiating a secondary authentication process for a subscriber entity. A method is performed by a UPF entity. The method includes monitoring user plane traffic of an already established PDU session for the subscriber entity. The user plane traffic is monitored for a request from the subscriber entity to access an application service of a data network. Observing the request triggers the UPF entity to initiate the secondary authentication process for the subscriber entity for allowing the subscriber entity to access the application service. The method includes sending a notification to an SMF entity to initiate the secondary authentication process for the subscriber entity upon having observed the trigger.

### TECHNICAL FIELD

Embodiments presented herein relate to a method, a User Plane Function entity, a computer program, and a computer program product for initiating a secondary authentication process for a subscriber entity. Embodiments presented herein further relate to a method, a Session Management Function entity, a computer program, and a computer program product for initiating a secondary authentication process for the subscriber entity.

### BACKGROUND

In communications networks, there may be a challenge to obtain good performance and capacity for a given communications protocol, its parameters and the physical environment in which the communications network is deployed.

For example, secondary authentication is a technique that is defined in the technical specification 3GPP TS 33.501 “Security architecture and procedures for 5G System” (latest version: 17.6.0) to facilitate authentication of a subscriber entity (as represented by a user equipment; UE) with a data network that is outside the operator network domain. To support this functionality, different Extensible Authentication Protocol (EAP) based authentication methods and associated credentials can be used.

Typically, these are controlled, or managed, by the data network and not by the operator.

As defined in the aforementioned technical specification 3GPP TS 33.501 in section 11.1, the secondary authentication is triggered by a Session Management Function (SMF) upon receiving a request of a protocol data unit (PDU) session establishment from the UE. This PDU session establishment process is by the UE requested to the SMF after the primary authentication for the UE has been concluded. The SMF then obtains necessary information from a Unified Data Management (UDM) to check the validity of this request and whether a secondary authentication is needed or not. If secondary authentication is required, the SMF triggers an EAP authentication with a data network (DN) authentication, authorization, and accounting (AAA) server. After the successful authentication between the UE and the DN-AAA server, a User Plane Function (UPF) and the SMF receives an EAP-success message from the DN-AAA server. This indicates a successful EAP authentication. Then the SMF continues the process of establishing the requested PDU session for the UE.

One purpose of the secondary authentication is to restrict access for the UE to a given data network (e.g., an enterprise network) to only legitimate users. UEs that cannot perform successful secondary authentication towards the DN-AAA server would not be allowed to access that given data network.

As disclosed above, the secondary authentication is triggered only when a new PDU session establishment is requested by a UE, or during a re-authentication process (e.g., where the DN-AAA server can request re-authentication for an already (secondary) authenticated PDU session). This limits the cases where secondary authentication is actually triggered.

### SUMMARY

An object of embodiments herein is to address the above issues.

A particular object is to enable secondary authentication to be triggered in other cases than disclosed above.

According to a first aspect there is presented a method for initiating a secondary authentication process for a subscriber entity. The method is performed by a UPF entity. The method comprises monitoring user plane traffic of an already established PDU session for the subscriber entity. The user plane traffic is monitored for a request from the subscriber entity to access an application service of a data network. Observing the request triggers the UPF entity to initiate the secondary authentication process for the subscriber entity for allowing the subscriber entity to access the application service. The method comprises sending a notification to an SMF entity to initiate the secondary authentication process for the subscriber entity upon having observed the trigger.

According to a second aspect there is presented a UPF entity for initiating a secondary authentication process for a subscriber entity. The UPF entity comprises processing circuitry. The processing circuitry is configured to cause the UPF entity to monitor user plane traffic of an already established PDU session for the subscriber entity. The user plane traffic is monitored for a request from the subscriber entity to access an application service of a data network. Observing the request triggers the UPF entity to initiate the secondary authentication process for the subscriber entity for allowing the subscriber entity to access the application service. The processing circuitry is configured to cause the UPF entity to send a notification to an SMF entity to initiate the secondary authentication process for the subscriber entity upon having observed the trigger.

According to a third aspect there is presented a UPF entity for initiating a secondary authentication process for a subscriber entity. The UPF entity comprises a monitor module configured to monitor user plane traffic of an already established PDU session for the subscriber entity. The user plane traffic is monitored for a request from the subscriber entity to access an application service of a data network. Observing the request triggers the UPF entity to initiate the secondary authentication process for the subscriber entity for allowing the subscriber entity to access the application service. The UPF entity comprises a send module configured to send a notification to an SMF entity to initiate the secondary authentication process for the subscriber entity upon having observed the trigger.

According to a fourth aspect there is presented a computer program for initiating a secondary authentication process for a subscriber entity, the computer program comprising computer program code which, when run on processing circuitry of a UPF entity, causes the UPF entity to perform a method according to the first aspect.

According to a fifth aspect there is presented a method for initiating a secondary authentication process for a subscriber entity. The method is performed by an SMF entity. The method comprises receiving a notification from a UPF entity to initiate the secondary authentication process for the subscriber entity. The notification comprises information about the application service that the subscriber entity requests to access and/or a data network providing the application service. The method comprises initiating, without checking any PDU session information of the subscriber entity except verifying that the application service is belonging to an already established PDU session for the subscriber entity, a server to perform the secondary authentication process for the subscriber entity.

According to a sixth aspect there is presented an SMF entity for initiating a secondary authentication process for a subscriber entity. The SMF entity comprises processing circuitry. The processing circuitry is configured to cause the SMF entity to receive a notification from a UPF entity to initiate the secondary authentication process for the subscriber entity. The notification comprises information about the application service that the subscriber entity requests to access and/or a data network providing the application service. The processing circuitry is configured to cause the SMF entity to initiate, without checking any PDU session information of the subscriber entity except verifying that the application service is belonging to an already established PDU session for the subscriber entity, a server to perform the secondary authentication process for the subscriber entity.

According to a seventh aspect there is presented an SMF entity for initiating a secondary authentication process for a subscriber entity. The SMF entity comprises a receive module configured to receive a notification from a UPF entity to initiate the secondary authentication process for the subscriber entity. The notification comprises information about the application service that the subscriber entity requests to access and/or a data network providing the application service. The SMF entity comprises an initiate module configured to initiate, without checking any PDU session information of the subscriber entity except verifying that the application service is belonging to an already established PDU session for the subscriber entity, a server to perform the secondary authentication process for the subscriber entity.

According to an eighth aspect there is presented a computer program for initiating a secondary authentication process for a subscriber entity, the computer program comprising computer program code which, when run on processing circuitry of an SMF entity, causes the SMF entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects do not require secondary authentication to be performed by definition at establishment of a new PDU session.

Advantageously, these aspects enable secondary authentication to be performed on a per need basis for the subscriber entity.

Advantageously, these aspects can be used to support zero-trust network access from a cellular network.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIG. 4 is a signalling diagram according to an embodiment;

FIG. 5 is a schematic diagram showing functional units of a UPF entity according to an embodiment;

FIG. 6 is a schematic diagram showing functional modules of a UPF entity according to an embodiment;

FIG. 7 is a schematic diagram showing functional units of an SMF entity according to an embodiment;

FIG. 8 is a schematic diagram showing functional modules of an SMF entity according to an embodiment; and

FIG. 9 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

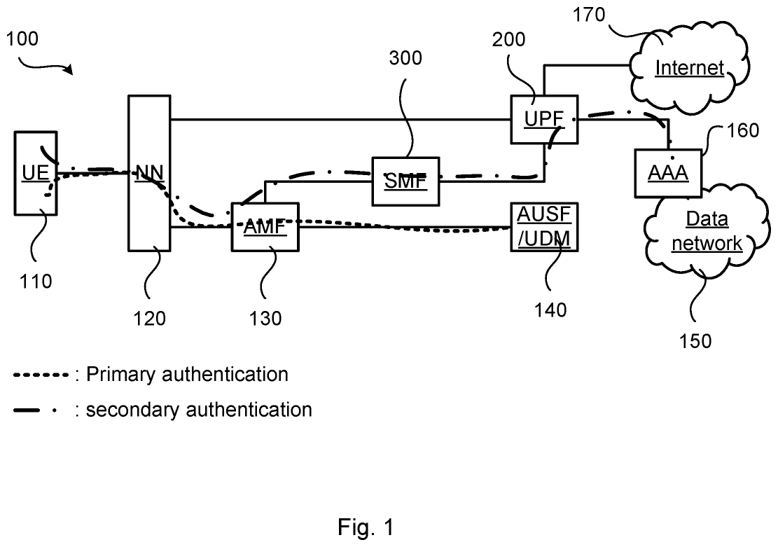

FIG. 1 is a schematic diagram illustrating a communication network 100 where embodiments presented herein can be applied. Only those network entities of relevance for the present disclosure are illustrated in FIG. 1. As is understood, the communication network 100 comprises further entities in addition to those illustrated. The communication network 100 comprises a network node 120 to which a subscriber entity 110, in terms of a user equipment (UE), is operatively connected. The network node 120 could be any, or any combination, of a (radio) access network node, radio base station, base transceiver station, node B, evolved node B, gNB, access point, access node, integrated access and backhaul node. The subscriber entity 110 might be provided in any of a portable wireless device, mobile station, mobile phone, handset, wireless local loop phone, smartphone, laptop computer, tablet computer, wireless modem, wireless sensor device, unmanned vehicle, Internet of Things device, or the like. The communication network 100 further comprises an Access and Mobility management Function (AMF) 130, an Authentication Server Function (AUSF)/UDM 140, a data network 150 (such as an enterprise data network), an EAP server 160 (also referred to as DN-AAA server), a public data network 170, such as the Internet, a UPF entity 200, and an SMF entity 300.

As disclosed above, the secondary authentication is triggered only when a new PDU session establishment is requested by a UE, or during a re-authentication process (e.g., where the DN-AAA server can request re-authentication for an already (secondary) authenticated PDU session). This limits the cases where secondary authentication is actually triggered.

The embodiments disclosed herein thus relate to techniques for initiating a secondary authentication process for a subscriber entity 110. In order to obtain such techniques there is provided a UPF entity 200, a method performed by the UPF entity 200, a computer program product comprising code, for example in the form of a computer program, that when run on processing circuitry of the UPF entity 200, causes the UPF entity 200 to perform the method. In order to obtain such techniques there is further provided an SMF entity 300, a method performed by the SMF entity 300, and a computer program product comprising code, for example in the form of a computer program, that when run on processing circuitry of the SMF entity 300, causes the SMF entity 300 to perform the method.

According to at least some of the herein disclosed embodiments, secondary authentication can be used for an already established PDU session. In this case, the UPF entity 200 will trigger the secondary authentication process instead of the SMF entity 300. In order to achieve this, the UPF entity 200 is configured to monitor the user plane traffic and to initiate secondary authentication process when needed. It is assumed that the SMF entity 300 is aware of this functionality. The SMF entity 300 will then accept triggers from the UPF entity 200 to start secondary authentication for the subscriber entity 110.

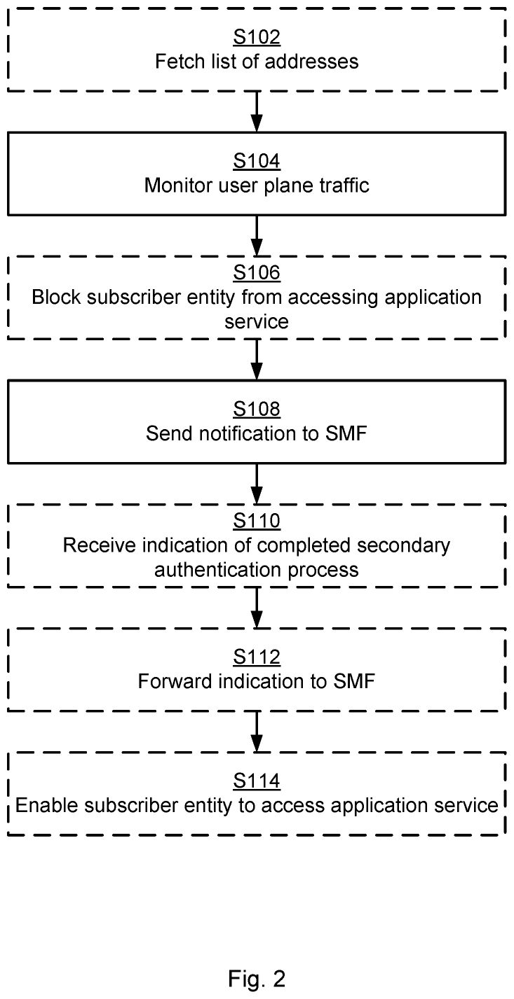

Reference is now made to FIG. 2 illustrating a method for initiating a secondary authentication process for a subscriber entity 110 as performed by the UPF entity 200 according to an embodiment.

S104: The UPF entity 200 monitors user plane traffic of an already established PDU session for the subscriber entity 110. The user plane traffic is monitored for a request from the subscriber entity 110 to access an application service of a data network 150. Observing the request triggers the UPF entity 200 to initiate the secondary authentication process for the subscriber entity 110 for allowing the subscriber entity 110 to access the application service.

S108: The UPF entity 200, upon having observed the trigger, sends a notification to the SMF entity 300 to initiate the secondary authentication process for the subscriber entity 110.

Embodiments relating to further details of for initiating a secondary authentication process for a subscriber entity 110 as performed by the UPF entity 200 will now be disclosed.

In some embodiments, the UPF entity 200 acts as router and network access controller for the data network 150.

The notification might in S108 be sent to the SMF entity 300 on an already established N4 session between the UPF entity 200 and the SMF entity 300.

The notification might, optionally, comprises information about the resource the subscriber entity 110 is trying to access. That is, in some embodiments, the notification comprises information about the application service that the subscriber entity 110 requests to access and/or the data network 150.

In terms of the PDU session, the data from the subscriber entity 110 might be routed via the UPF entity 200 to the data network 150 and to the Internet. That is, in some embodiments, the PDU session is established between the subscriber entity 110 and a public data network 170, as well as between the subscriber entity 110 and the data network 150.

The UPF entity 200 might be configured to detect (and block access for) subscriber entities 110 trying to access a specific address, or Uniform Resource Locator (URL), that requires secondary authentication. In some examples, the address is an IP address and/or is represented by a Domain Name System (DNS) query in the request. The UPF entity 200 then triggers secondary authentication for the subscriber entity 110. Hence, in some embodiments, the request includes an address of the data network 150, and the UPF entity 200 is triggered to initiate the secondary authentication only when either the address is part of a list of addresses for which secondary authentication of the subscriber entity 110 is required or the address is not part of a set of trusted addresses. In some examples, the UPF entity 200 might allow traffic to a certain set of addresses, and if the UPF entity 200 detects a request for an address that is currently not allowed (i.e., matches a generic block firewall rule) the UPF entity 200 triggers secondary authentication for the requested address.

In general terms, the UPF entity 200 might be configured with routing and firewall capabilities. The UPF entity 200 might be configured locally, or by a Policy Control Function (PCF) for policies to be used for the subscriber entity 110. In particular, in some embodiments, the list of addresses is locally stored in the UPF entity 200.

In other examples, the list of addresses is by the UPF entity 200 fetched from another entity, such as from a central policy database in the core network. In particular, in some embodiments, the UPF entity 200 further is configured to perform (optional) step S102.

### S102: the Upf Entity 200 Fetches the List of Addresses From a Core Network Central policy database.

Until the secondary authentication is complete, the subscriber entity 110 might not be allowed to access the particular data network or application service for which secondary authentication is needed. In this respect, in some aspects, the UPF entity 200 blocks, or drops, packets sent to the service until the secondary authentication has been successfully completed. Hence, in some embodiments, the UPF entity 200 further is configured to perform (optional) step S106.

S106: The UPF entity 200 blocks the subscriber entity 110 from accessing the application service until the UPF entity 200 receives an indication that the secondary authentication process has been completed for the subscriber entity 110.

In some aspects, an EAP success message is either communicated from the EAP server 160 to the SMF entity 300 via the UPF entity 200 or via the SMF entity 300 to the UPF entity 200. Hence, in some embodiments, the UPF entity 200 further is configured to perform (optional) steps S110 and S112.

S110: The UPF entity 200 receives an indication from the EAP server 160 that the secondary authentication process has been completed for the subscriber entity 110.

S112: the Upf Entity 200 Forwards the Indication to the Smf Entity 300.

Based on the EAP authentication result, the UPF entity 200 determines whether to allow the traffic for the subscriber entity 110 to flow to the specific external data network or not. Hence, in some embodiments, the UPF entity 200 further is configured to perform (optional) step S114.

S114: The UPF entity 200 enables, upon having received the indication, the subscriber entity 110 to access the application service.

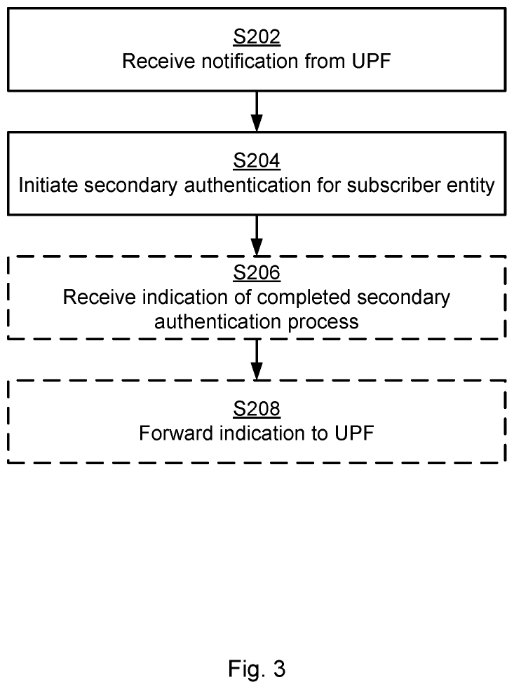

Reference is now made to FIG. 3 illustrating a method for initiating a secondary authentication process for a subscriber entity 110 as performed by the SMF entity 300 according to an embodiment.

In general terms, the SMF entity 300 triggers secondary authentication in conjunction with a PDU session establishment request. Typically, the SMF entity 300 obtains this PDU session establishment request, checks validity, subscriber information and policies, and then triggers the secondary authentication if needed, and then finally continues to setup the PDU session upon successful secondary authentication. Further, the SMF entity 300 starts secondary authentication when a re-authentication is needed. A re-authentication can be triggered either by the SMF entity 300 or by the DN-AAA server. If the re-authentication is triggered by the DN-AAA server, then the DN-AAA server sends a Secondary Re-Authentication request via the UPF entity 200 (where the UPF entity 200 forwards the request to the SMF entity 300). The Secondary Re-authentication request contains the Generic Public Subscription Identifier (GPSI), if available, and the IP and/or Media Access Control (MAC) address of the subscriber entity 110 allocated to the PDU session and the MAC address if the PDU session is of Ethernet PDU type.

During re-authentication, the SMF entity 300 has already some previous knowledge from the first secondary authentication process, but in the present case, the SMF entity 300 might not have access to such information. According to the herein disclosed embodiments, the re-authentication command will be originated from the UPF entity 200. In fact, the re-authentication command will not be for re-authentication, but rather be a standalone secondary authentication (regardless of whether secondary authentication has been performed when the PDU session was established or not).

S202: The SMF entity 300 receives a notification from the UPF entity 200 to initiate the secondary authentication process for the subscriber entity 110. The notification comprises information about the application service that the subscriber entity 110 requests to access and/or a data network 150 providing the application service.

S204: The SMF entity 300 initiates, without checking any PDU session information of the subscriber entity 110 except, optionally, verifying that the application service is belonging to an already established PDU session for the subscriber entity 110, the server 160 to perform the secondary authentication process for the subscriber entity 110.

Embodiments relating to further details of initiating a secondary authentication process for a subscriber entity 110 as performed by the SMF entity 300 will now be disclosed.

The notification in S202 might be received from the UPF entity 200 on an already established N4 session between the SMF entity 300 and the UPF entity 200.

Information received as part of the notification can be used by the SMF entity 300 when selecting EAP/AAA server 160 (for example, if the identity provided by the subscriber entity 110 is not informative enough). In particular, in some embodiments, which server 160 to perform the secondary authentication process for the subscriber entity 110 is selected as a function of the information about the application service and/or the data network 150.

As disclosed above, in some aspects, an EAP success message is either communicated from the EAP/AAA server 160 to the SMF entity 300 via the UPF entity 200 or via the SMF entity 300 to the UPF entity 200. Hence, in some embodiments, the SMF entity 300 is configured to perform (optional) steps S206 and S208.

S206: The SMF entity 300 receives an indication from the server 160 that the secondary authentication process has been completed for the subscriber entity 110.

S208: The SMF entity 300 forwards the indication to the UPF entity 200.

In some examples, the DN-AAA server 160 is located outside the operator network and is managed and operated by the data network. However, alternatively, the DN-AAA server 160 is placed inside the core network. The latter allows the SMF entity 300 to set up a direct communication link with the DN-AAA server 160 rather than having an indirect communication link going via the UPF entity 200. This also enables the DN-AAA server 160 to be operated and managed by the network operator.

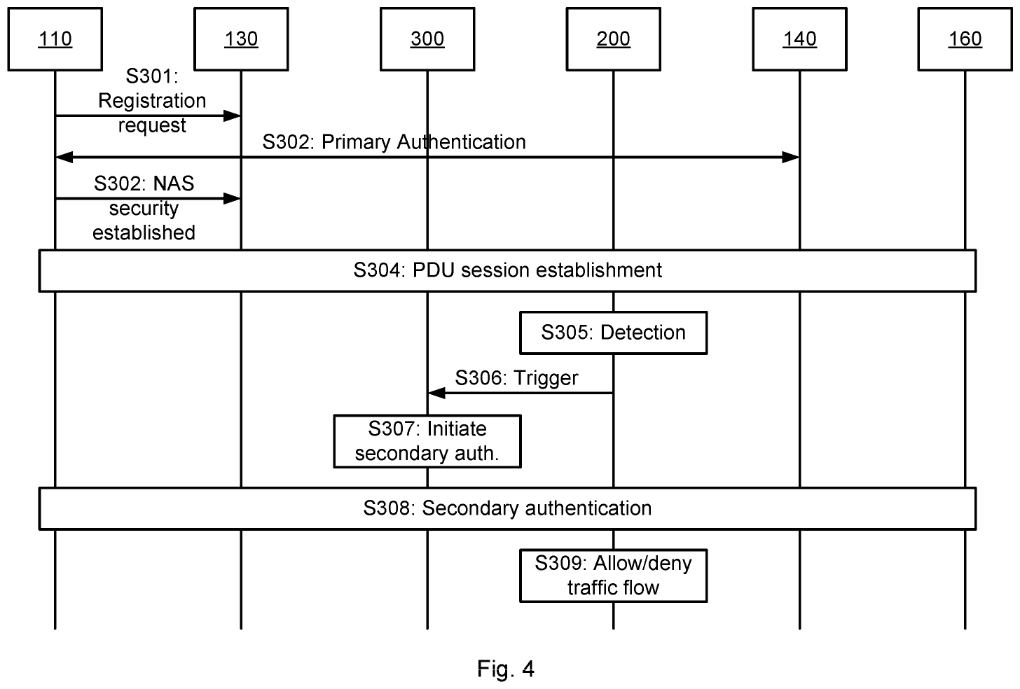

One particular embodiment for initiating a secondary authentication process for a subscriber entity 110 based on at least some of the above disclosed embodiments will now be disclosed in detail with reference to the signalling diagram of FIG. 4.

After the primary authentication and PDU session establishment (for a generic PDU session such as for a mobile broadband (MBB) session), data from the subscriber entity 110 is routed via the UPF entity 200 to the Internet and/or to a data network. Here, the UPF entity 200 is acting as a router and an access controller for the data network. The UPF entity 200 is configured to continuously monitor the traffic for the subscriber entity 110 and once the UPF entity 200 notices that a new session establishment process has started for a particular subscriber entity 110 to a specific data network service where there is a policy for a secondary authentication, the UPF entity 200 will trigger secondary authentication for the subscriber entity 110 to the SMF entity 300. Until the secondary authentication is complete, the subscriber entity 110 will not be allowed to access that specific data network service.

S301: The subscriber entity 110 provides a registration request to attach to an operator network.

S302: Primary authentication takes place for the subscriber entity 110 to attach to the network.

S303: After successful primary authentication, the subscriber entity 110 establishes a non-access stratum (NAS) security context with the AMF 130.

S304: The subscriber entity 110 initiates establishment of a new PDU session by sending a NAS message containing a PDU Session Establishment Request. The process follows section 4.3.2.2 in the technical specification 3GPP TS 23.502 “Procedures for the 5G System (5GS)” (latest version: 17.5.0) to establish the PDU session. The PDU session could, optionally, require secondary authentication, but whether that is the case is not relevant here. For example, the PDU session could be used for public Internet access where thus secondary authentication would not be needed.

S305: The subscriber entity 110 continues to send and/or receive data using the PDU session and the UPF entity 200 continues to monitor traffic for the subscriber entity 110. The UPF entity 200 might in this respect act as an access gateway for external data networks based on policies for the subscriptions. If the UPF entity 200 notices that the subscriber entity 110 is requesting, or trying to access, a resource from a data network that has a policy requiring secondary authentication, then the UPF entity 200 blocks the traffic and triggers the SMF entity 300 to perform secondary authentication for the subscriber entity 110. This detection can be performed based on the destination IP address, or by inspecting the DNS query of the outgoing traffic. The UPF entity 200 might either have the policies locally stored for subscriber entities 110 or the UPF entity 200 might fetch the policies from some central policy database in the core network.

S306: The UPF entity 200 sends a notification for the SMF entity 300 to initiate secondary authentication for the subscriber entity 110. Here it is assumed that there is already a session (such as an N4 session) established between the SMF entity 300 and the UPF entity 200. The notification might, optionally, comprise information about the resource the subscriber entity 110 is trying to access. This information can be used by the SMF entity 300 when selecting DN-AAA server 160.

S307: The SMF entity 300 initiates EAP authentication for the subscriber entity 110 as per section 11.1 in the aforementioned technical specification 3GPP TS 33.501.

Typically, initiating EAP authentication for the subscriber entity 110 occurs in conjunction with PDU session establishment, but in the present context the SMF entity 300 only needs to initiate and complete the EAP authentication rather than checking other PDU session related information (based e.g., on that the SMF entity 300 knows which UPF entity 200 to use, and that a communication link with that UPF entity 200 has already been established).

S308: EAP authentication for the subscriber entity 110 is completed. If successful, then an EAP success message is provided to the UPF entity 200 and the SMF entity 300. This indicates that the secondary authentication for the subscriber entity 110 was successful. According to one alternative, the EAP success message is communicated from the DN-AAA server 160 to the SMF entity 300 via the UPF entity 200. According to another alternative, the EAP success message is communicated from the DN-AAA server 160 to the UPF entity 200 via the SMF entity 300 as a response to the message sent in step S306.

S309: Upon successful EAP authentication, the UPF entity 200 determines whether to allow the traffic for the subscriber entity 110 to flow to the specific service in the external data network or not. There could be a secure channel between the UPF entity 200 and the external data network through which the traffic of the secondary authenticated subscriber entity 110 is sent to the service, including e.g., an access token, so the service can grant access for the specific subscriber entity 110.

Step S305-S309 could be repeated as needed for the subscriber entity 110 when requesting, or trying to access, any further resource and/or from a further data network that has a policy requiring secondary authentication.

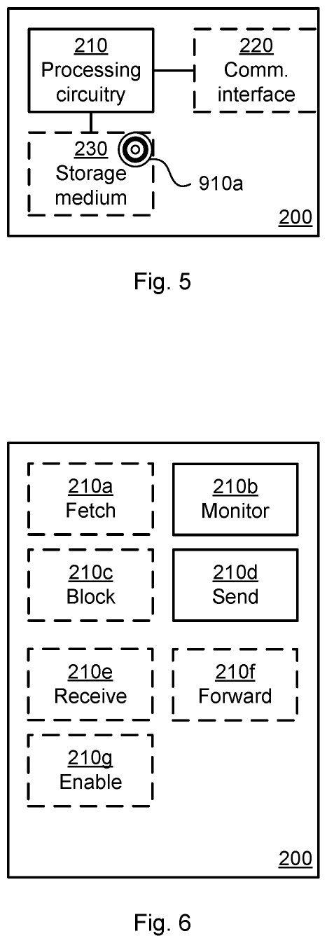

FIG. 5 schematically illustrates, in terms of a number of functional units, the components of a UPF entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the UPF entity 200 to perform a set of operations, or steps, as disclosed above. For example, the storage medium 230 may store the set of operations, and the processing circuitry 210 may be configured to retrieve the set of operations from the storage medium 230 to cause the UPF entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The UPF entity 200 may further comprise a communications interface 220 for communications with other entities, functions, nodes, and devices, as in FIG. 1. As such the communications interface 220 may comprise one or more transmitters and receivers, comprising analogue and digital components.

The processing circuitry 210 controls the general operation of the UPF entity 200 e.g. by sending data and control signals to the communications interface 220 and the storage medium 230, by receiving data and reports from the communications interface 220, and by retrieving data and instructions from the storage medium 230. Other components, as well as the related functionality, of the UPF entity 200 are omitted in order not to obscure the concepts presented herein.

FIG. 6 schematically illustrates, in terms of a number of functional modules, the components of a UPF entity 200 according to an embodiment. The UPF entity 200 of FIG. 6 comprises a number of functional modules; a monitor module 210b configured to perform step S104, and a send module 210d configured to perform step S108. The UPF entity 200 of FIG. 6 may further comprise a number of optional functional modules, such as any of a fetch module 210a configured to perform step S102, a block module 210c configured to perform step S106, a receive module 210e configured to perform step S110, a forward module 210f configured to perform step S112, a enable module 210g configured to perform step S114.

In general terms, each functional module 210a:210g may be implemented in hardware or in software. Preferably, one or more or all functional modules 210a:210g may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210g and to execute these instructions, thereby performing any steps of the UPF entity 200 as disclosed herein.

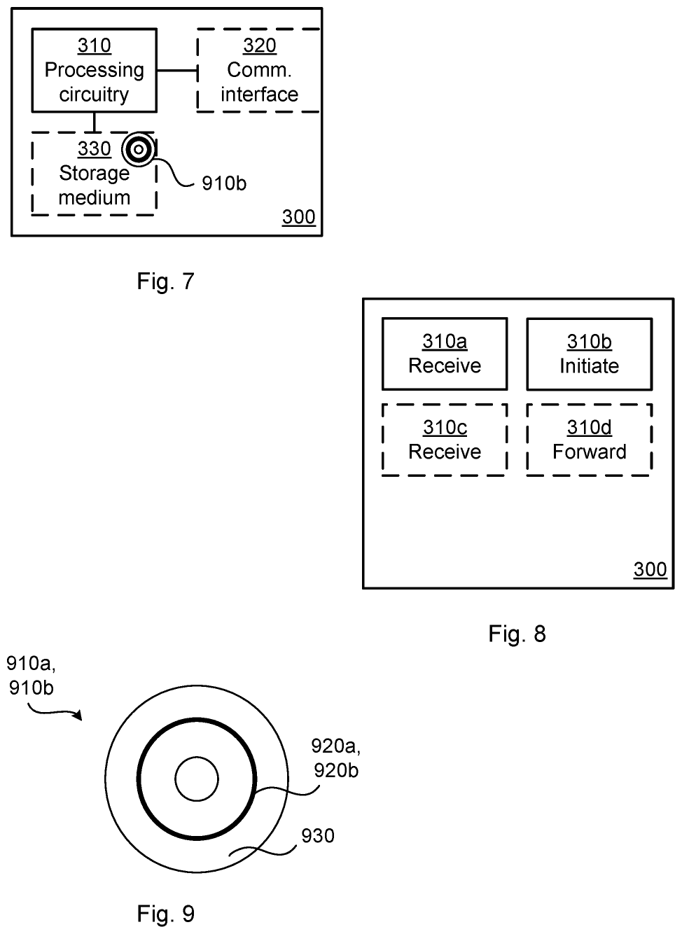

FIG. 7 schematically illustrates, in terms of a number of functional units, the components of an SMF entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the SMF entity 300 to perform a set of operations, or steps, as disclosed above. For example, the storage medium 330 may store the set of operations, and the processing circuitry 310 may be configured to retrieve the set of operations from the storage medium 330 to cause the SMF entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The SMF entity 300 may further comprise a communications interface 320 for communications with other entities, functions, nodes, and devices, as in FIG. 1. As such the communications interface 320 may comprise one or more transmitters and receivers, comprising analogue and digital components.

The processing circuitry 310 controls the general operation of the SMF entity 300 e.g. by sending data and control signals to the communications interface 320 and the storage medium 330, by receiving data and reports from the communications interface 320, and by retrieving data and instructions from the storage medium 330. Other components, as well as the related functionality, of the SMF entity 300 are omitted in order not to obscure the concepts presented herein.

FIG. 8 schematically illustrates, in terms of a number of functional modules, the components of an SMF entity 300 according to an embodiment. The SMF entity 300 of FIG. 8 comprises a number of functional modules; a receive module 310a configured to perform step S202, and an initiate module 310b configured to perform step S204. The SMF entity 300 of FIG. 8 may further comprise a number of optional functional modules, such as any of a receive module 310c configured to perform step S206, and a forward module 310d configured to perform step S208. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the SMF entity 300 as disclosed herein.

The UPF entity 200 and/or the SMF entity 300 may be provided as a standalone device or as a part of at least one further device. For example, the UPF entity 200 and/or the SMF entity 300 may be provided in a node of the core network. Alternatively, functionality of the UPF entity 200 and/or the SMF entity 300 may be distributed between at least two devices, or nodes. These at least two nodes, or devices, may either be part of the same network part (such as the core network) or may be spread between at least two such network parts. In general terms, instructions that are required to be performed in real time may be performed in a device, or node, operatively closer to the cell than instructions that are not required to be performed in real time. Thus, a first portion of the instructions performed by the UPF entity 200 and/or the SMF entity 300 may be executed in a first device, and a second portion of the instructions performed by the UPF entity 200 and/or the SMF entity 300 may be executed in a second device; the herein disclosed embodiments are not limited to any particular number of devices on which the instructions performed by the UPF entity 200 and/or the SMF entity 300 may be executed. Hence, the methods according to the herein disclosed embodiments are suitable to be performed by a UPF entity 200 and/or the SMF entity 300 residing in a cloud computational environment. Therefore, although a single processing circuitry 210, 310 is illustrated in FIGS. 5 and 7 the processing circuitry 210, 310 may be distributed among a plurality of devices, or nodes. The same applies to the functional modules 210a:210g, 310a:310d of FIGS. 6 and 8 and the computer programs 920a, 920b of FIG. 9.

FIG. 9 shows one example of a computer program product 910a, 910b comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the UPF entity 200 as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the SMF entity 300 as herein disclosed.

In the example of FIG. 9, the computer program product 910a, 910b is illustrated as an optical disc, such as a CD (compact disc) or a DVD (digital versatile disc) or a Blu-Ray disc. The computer program product 910a, 910b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b is here schematically shown as a track on the depicted optical disk, the computer program 920a, 920b can be stored in any way which is suitable for the computer program product 910a, 910b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for initiating a secondary authentication process for a subscriber entity, the method being performed by a User Plane Function, UPF, entity the method comprising:
monitoring user plane traffic of an already established protocol data unit, PDU, session for the subscriber entity, the user plane traffic being monitored for a request from the subscriber entity to access an application service of a data network, and wherein observing the request triggers the UPF entity to initiate the secondary authentication process for the subscriber entity for allowing the subscriber entity to access the application service; and
sending a notification to a Session Management Function, SMF, entity to initiate the secondary authentication process for the subscriber entity upon having observed the trigger.

2. The method according to claim 1, wherein the request includes an address of the data network, and wherein the UPF entity is triggered to initiate the secondary authentication only when either the address is part of a list of addresses for which secondary authentication of the subscriber entity is required or the address is not part of a set of trusted addresses.

3. The method according to claim 2, wherein the address is one or both of an IP address and represented by a DNS query in the request.

4. The method according to claim 2, wherein the list of addresses is locally stored in the UPF entity.

5. The method according to claim 2, wherein the method further comprises:
fetching the list of addresses from a core network central policy database.

6. The method according to claim 1, wherein the method further comprises:
blocking the subscriber entity from accessing the application service until receiving an indication that the secondary authentication process has been completed for the subscriber entity.

7. The method according to claim 1, wherein the method further comprises:
receiving an indication from a server that the secondary authentication process has been completed for the subscriber entity; and
forwarding the indication to the SMF entity.

8. The method according to claim 7, wherein the method further comprises:
enabling, upon having received the indication, the subscriber entity to access the application service.

9. The method according to claim 1, wherein the PDU session is established between the subscriber entity and a public data network, as well as between the subscriber entity and the data network.

10. The method according to claim 1, wherein the UPF entity acts as router and network access controller for the data network.

11. The method according to claim 1, wherein the notification is sent to the SMF entity on an already established N4 session between the UPF entity and the SMF entity.

12. The method according to claim 1, wherein the notification comprises information about one or both of the application service that the subscriber entity requests to access and the data network.

13. A method for initiating a secondary authentication process for a subscriber entity, the method being performed by a Session Management Function, SMF, entity, the method comprising:
receiving a notification from a User Plane Function, UPF, entity to initiate the secondary authentication process for the subscriber entity, the notification comprising information about one or both of the application service that the subscriber entity requests to access and a data network providing the application service; and
initiating, without checking any protocol data unit, PDU, session information of the subscriber entity except verifying that the application service is belonging to an already established PDU session for the subscriber entity, a server to perform the secondary authentication process for the subscriber entity.

14. The method according to claim 13, wherein which server to perform the secondary authentication process for the subscriber entity is selected as a function of the information about the one or both of the application service and the data network.

15. The method according to claim 13, wherein the method further comprises:
receiving an indication from the server that the secondary authentication process has been completed for the subscriber entity; and
forwarding the indication to the UPF entity.

16. The method according to claim 13, wherein the notification is received from the UPF entity on an already established N4 session between the SMF entity and the UPF entity.

17. A User Plane Function, UPF, entity for initiating a secondary authentication process for a subscriber entity, the UPF entity comprising processing circuitry, the processing circuitry being configured to cause the UPF entity to:
monitor user plane traffic of an already established protocol data unit, PDU, session for the subscriber entity, the user plane traffic being monitored for a request from the subscriber entity to access an application service of a data network, and observing the request triggers the UPF entity to initiate the secondary authentication process for the subscriber entity for allowing the subscriber entity to access the application service; and
send a notification to a Session Management Function, SMF, entity to initiate the secondary authentication process for the subscriber entity upon having observed the trigger.

18. (canceled)

19. The UPF entity according to claim 17, wherein the request includes an address of the data network, and wherein the UPF entity further configured to be triggered to initiate the secondary authentication only when either the address is part of a list of addresses for which secondary authentication of the subscriber entity is required or the address is not part of a set of trusted addresses.

20. A Session Management Function, SMF, entity for initiating a secondary authentication process for a subscriber entity, the SMF entity comprising processing circuitry, the processing circuitry being configured to cause the SMF entity to:
receive a notification from a User Plane Function, UPF, entity to initiate the secondary authentication process for the subscriber entity, the notification comprising information about one or both of the application service that the subscriber entity requests to access and a data network providing the application service; and
initiate, without checking any protocol data unit, PDU, session information of the subscriber entity except verifying that the application service is belonging to an already established PDU session for the subscriber entity, a server to perform the secondary authentication process for the subscriber entity.

21. (canceled)

22. The SMF entity according to claim 20, wherein which server to perform the secondary authentication process for the subscriber entity is selected as a function of the information about the one or both of the application service and the data network.

23-25. (canceled)
